(19) United States
(12) Patent Application Publication
(10) Pub. No.: US 2007/0040374 A1
(43) Pub. Date: Feb. 22, 2007

(54) Device for determining vehicle-occupant-related variables in a vehicle

(75) Inventors: Wilfried Bullinger, Korntal-Muenchingen (DE); Walter Eberle, Hochdorf (DE); Martin Fritzsche, Biberach (DE); Carsten Lorenz, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/505,310

(22) Filed: Aug. 17, 2006

(30) Foreign Application Priority Data
Aug. 18, 2005 (DE) 10 2005 039 029.3

(51) Int. Cl. B60R 22/20; B60R 21/00

(52) U.S. Cl. 280/801.2; 180/268

(57) ABSTRACT

A device is provided for determining vehicle-occupant-related variables in a vehicle, which comprises a seatbelt with a seatbelt deflector which can be set with respect to its position. A sensor can be provided for sensing the position of the seatbelt deflector.

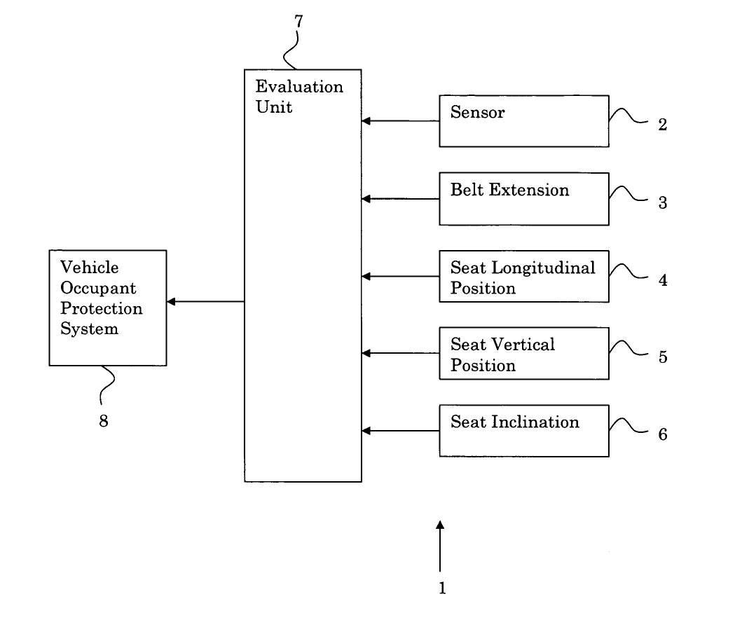

### CROSS REFERENCE TO RELATED APPLICATIONS

This application claims priority under 35 U.S.C. § 119 to German Patent Application No. 10 2005 039 029.3, filed Aug. 18, 2005, the entire disclosure of which is herein expressly incorporated by reference.

### BACKGROUND AND SUMMARY OF THE INVENTION

The present invention relates to a device for determining vehicle-occupant-related variables in a vehicle.

DE 41 23 164 C2 discloses a device for setting the position of a belt deflector of a seatbelt. The belt deflector is attached to a carriage which is mounted in a sliding fashion on a rail which is provided with indents. The carriage can be locked in the indents on the rail by two pressure-loaded locking bolts. Various positions for the height of the belt deflector can be predefined in accordance with the predefined indents.

DE 101 36 267 A1 describes a sensor system for sensing an extension of a seatbelt with an extension/retraction belt reel around which the seatbelt is wound. A sensor senses a position of the seatbelt during use. The sensor comprises a magnet and a Hall sensor which are arranged on opposite sides of the seatbelt. The Hall sensor measures the strength of the magnetic field of the magnet. The seatbelt has, in particular, a ferromagnetic mark which is sensed by the Hall sensor when the mark is located between the magnet and the Hall sensor. The ferromagnetic mark may be embodied, for example, in the form of a strip.

Furthermore, DE 199 46 072 A1 discloses a measuring device for measuring an extension length of a seatbelt of a restraining system. The seatbelt is wound onto a reel which is borne by a shaft. By counting the revolutions of the shaft, a revolution sensor senses the extension length of the seatbelt. The output signal of the revolution sensor is a measure of the extension length of the seatbelt.

In addition, DE 196 10 833 A1 describes a method for specifying the vehicle occupant weight of a vehicle occupant sitting on a vehicle seat. To do this, the length of a belt extension which is pulled out of a rewinding device of a restraining system by the vehicle occupant is sensed. The length of the belt extension is a measure of the size of the vehicle occupant. The weight of the vehicle occupant is calculated as a function of the vehicle-occupant-related belt extension. The calculation is carried out using a predetermined formula or using predefined tables which assign an empirical value for the weight of the vehicle occupant to a specific length of the belt extension.

One object of the invention is to provide a device for determining vehicle-occupant-related variables in a vehicle, which makes available information about the vehicle occupant that is more comprehensive than that in the prior art.

Another object of the invention is to provide a method for determining the weight of a vehicle occupant sitting on a vehicle seat.

These and other objects and advantages are achieved according to the invention, by a device for determining vehicle-occupant-related variables in a vehicle, which comprises a seatbelt with a belt deflector which can be set with respect to its position. According to the invention, a sensor is provided for sensing the position of the belt deflector. The device for determining vehicle-occupant-related variables in a vehicle comprises the seatbelt with the belt deflector which can be set with respect to its position. The position of the belt deflector is set by the vehicle occupant himself, or is set automatically, and is a measure of the weight of the vehicle occupant. The position of the belt deflector can be set manually, for example, by a latching system. When the position of the belt deflector is set automatically, the belt deflector can be set concomitantly or readjusted in parallel with automatic seat adjustment, in particular, by using a Bowden cable, over a predefined adjustment range.

In the predefined adjustment range there is a defined unique position of the belt deflector, stored in diagram form, for example, for each position of the seat. In one embodiment, the sensor for sensing the position of the belt deflector is a seat-position-sensing sensor, which senses a seat longitudinal position and/or a seat vertical position from which the position of the belt deflector can be derived. The seat-position-sensing sensor may be, for example, a component of an adjustment motor for setting the seat position.

When the position of a belt deflector whose position can be adjusted is sensed, a vehicle-occupant-related variable is determined which permits person-related and individualized actuation of protective measures. For example, a vehicle occupant-related triggering of an airbag system or vehicle-occupant-related actuation of the belt system can be provided as protective measures. The protective measures may also include, for example, individual actuation of force limiters and outflow openings in airbags or actuation of gas generator stages or firing times of a first and/or second gas generator.

In one refinement of the invention, the sensor for sensing the position of the belt deflector is a belt extension sensor. When a belt extension sensor is used, the sensing of the position of the belt deflector can be carried out at only low financial cost. The belt extension sensor is already integrated on a series production basis in many types of vehicles.

In a further refinement of the invention, the sensor comprises at least one switch by means of which the position of the belt deflector can be sensed. In this context, the switch can sense, in particular, a latched position of the belt deflector. Generally, a separate switch is used for position sensing for each latched position. Likewise, a potentiometer or some other continuously measuring sensor can be used as the switch.

The second-mentioned objective may be achieved by a method for determining the weight of a vehicle occupant sitting on a vehicle seat, in which method the belt extension of the vehicle occupant who is belted onto the vehicle seat is evaluated.

According to the invention, the position of the belt deflector is additionally taken into account in order to determine the weight of the vehicle occupant. The additional information about the position of the belt deflector permits more precise determination of the weight of the vehicle occupant sitting on the vehicle seat. The determination of weight can be carried out at only low cost. The use of pressure-sensitive mats in the upholstery of the seat, weight-measuring systems on the seat structure or camera systems for sensing the weight proves significantly more costly in comparison. In order to determine the weight of the vehicle occupant, a seat longitudinal position, a seat vertical position and/or a seat inclination can additionally be used to determine the weight of the vehicle occupant with relatively high precision.

Other objects, advantages and novel features of the present invention will become apparent from the following detailed description of the invention when considered in conjunction with the accompanying drawings.

### BRIEF DESCRIPTION OF THE DRAWING FIGURE

The FIGURE shows a detail from a device for determining vehicle-occupant-related variables in a vehicle in a box circuit diagram.

### DETAILED DESCRIPTION OF THE DRAWING

A device 1 for determining vehicle-occupant-related variables in a vehicle (not illustrated in more detail) comprises a seatbelt with a belt deflector whose position can be set. In order to sense the position of the belt deflector, according to the FIGURE a sensor 2 is provided which is embodied as a belt extension sensor in this exemplary embodiment. It is advantageous if the position of the belt deflector is sensed before manual activation of the seatbelt occurs.

In a method for determining the weight of a vehicle occupant sitting on a vehicle seat with the device 1 for determining vehicle-occupant-related variables in the vehicle, a belt extension 3 of the vehicle occupant who is belted onto the vehicle seat is sensed and evaluated. The weight of a vehicle occupant wearing a seatbelt can be determined by means of the belt extension at a specific seat longitudinal position 4. The weight of the vehicle occupant can be determined by a functional relationship between the size of the body and the belt extension 3 which is caused thereby.

In addition, in order to determine the weight of the vehicle occupant, the position of the belt deflector is sensed and taken into account. Adjustment of the belt deflector influences the sensing of the weight considerably, so that sensing the weight solely by the belt extension 3, which is caused by the vehicle occupant who is belted onto the vehicle seat, can cause the weight to be determined inaccurately.

The knowledge of the weight of the vehicle occupant and his vehicle occupant position or his sitting posture constitute, in addition to the severity of an accident, the most important input variables for the actuation of a vehicle-occupant restraining system. The knowledge of the position of the vehicle occupant, of the posture of the vehicle occupant, and of the distance of the vehicle occupant from a dashboard and, if appropriate, from the steering wheel is important for setting, for example, a belt force limitation and for the triggering time of an airbag. The weight of the vehicle occupant determines the level of the belt force limitation and of the restraining force of the airbag.

In order to improve further the accuracy of the determination of weight, it is also possible to take into account the seat longitudinal position 4, a seat vertical position 5 and/or a seat inclination 6 in order to determine the weight of the vehicle occupant. From these input parameters, a characteristic curve diagram is obtained for determining the weight of the vehicle occupant and for his distance from the dashboard and, if appropriate, from the steering wheel. The method for determining the weight of a vehicle occupant sitting on the vehicle seat can also be applied to vehicle seats in a rear area of the vehicle.

The weight of the vehicle occupant is determined in an evaluation unit 7. The evaluation unit 7 controls a vehicle occupant protection system 8 which may be, for example, an airbag system.

If the belt deflector has a latching system (not illustrated in more detail) for manually setting its position, the sensor 2 can alternatively have at least one switch with which one or more latched positions of the belt deflector are sensed. However, the sensing can equally well be carried out by the belt extension sensor. For this refinement, the belt deflector is attached to a B pillar of the vehicle. If sensor 2 has a switch, a separate belt extension sensor must be provided for determining the size of the vehicle occupant by the belt extension 3. If the position of the belt deflector is automatically adapted to a predefined seat position in a further refinement of the invention, with a defined position of the belt deflector being provided for each seat position, the sensor 2 is embodied as seat-position-sensing sensor which senses the seat longitudinal position 4 and/or the seat vertical position 5.

It is advantageous if the position of the belt deflector is sensed from the outside before a vehicle door opens or when the central locking system is activated.

The method according to the invention for determining the weight of a vehicle occupant sitting on the vehicle seat with the device 1 proves extremely reliable since the position of the belt deflector, as well as the size of the vehicle occupant, is taken into account to determine the weight of the vehicle occupant. The device 1 can be implemented with only low technical expenditure since the essential components of the device 1 are already integrated on a series production basis into various types of vehicle, providing an additional cost saving.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for determining vehicle-occupant-related variables in a vehicle which has a seatbelt with a seatbelt deflector whose position can be set, comprising:
a sensor configured to determine the position of the seatbelt deflector.

2. The device as claimed in claim 1, wherein the sensor is a seatbelt extension sensor.

3. The device as claimed in claim 1, wherein the sensor is a seat-position-sensing sensor which senses one of a longitudinal seat position or a vertical seat position.

4. The device as claimed in claim 1, wherein the sensor comprises at least one switch configured to sense the position of the seatbelt deflector.

5. The device as claimed in claim 4, wherein the at least one switch senses a latched position of the seatbelt deflector.

6. The device as claimed in claim 1, wherein the position of the seatbelt deflector is sensed from outside before a vehicle door opens or when a central locking system is activated.

7. The device as claimed in claim 1, wherein the position of the seatbelt deflector is sensed before manual activation of the seatbelt occurs.

8. The device as claimed in claim 1, wherein the sensor is a seat-position-sensing sensor which senses a seat longitudinal position and a seat vertical position.

9. A method for determining the weight of a vehicle occupant sitting on a vehicle seat in a vehicle which includes a seatbelt with a seatbelt deflector whose position can be set and a sensor that is configured to determine the position of the seatbelt deflector, the method comprising the acts of:
determining the position of the seatbelt deflector;
determining a degree of extension of the seatbelt of the vehicle occupant who is belted onto the vehicle seat; and
determining the weight of the vehicle occupant, based on the position of the seatbelt deflector and the determined extension of the seatbelt.

10. The method as claimed in claim 9, wherein at least one of a longitudinal seat position, a vertical seat position and a seat inclination is used to determine the weight of the vehicle occupant.

11. The method as claimed in claim 9, wherein the sensor comprises at least one switch configured to sense the position of the seatbelt deflector.

12. The method as claimed in claim 11, wherein the at least one switch senses a latched position of the seatbelt deflector.

13. The method as claimed in claim 9, wherein the position of the seatbelt deflector is sensed from outside before a vehicle door opens or when a central locking system is activated.

14. The method as claimed in claim 9, wherein the position of the seatbelt deflector is sensed before manual activation of the seatbelt occurs.

15. The method as claimed in claim 9, wherein a seat longitudinal position and a seat vertical position are also used to determine the position of the seatbelt deflector.

16. The method as claimed in claim 9, wherein a longitudinal seat position and a vertical seat position are also used to determine the weight of the vehicle occupant.

17. The method as claimed in claim 9, wherein a longitudinal seat position and a seat inclination are also used to determine the weight of the vehicle occupant.

18. The method as claimed in claim 9, wherein a vertical seat position and a seat inclination are also used to determine the weight of the vehicle occupant.

19. The method as claimed in claim 9, wherein a longitudinal seat position, a vertical seat position and a seat inclination are also used to determine the weight of the vehicle occupant.

20. A device for determining vehicle-occupant-related variables in a vehicle that has a seatbelt, comprising:
a seatbelt deflector having a position that can be set; and
a sensor configured to determine the position of the seatbelt deflector, the sensor comprising one of a seatbelt extension sensor configured to sense a degree of extension of the seatbelt, a seat-position-sensor configured to sense at least one of a longitudinal seat position, a vertical seat position and a seat inclination, and a switch configured to sense the position of the seatbelt deflector.
